(19) United States
(12) Patent Application Publication
(10) Pub. No.: US 2019/0128022 A1
(43) Pub. Date: May 2, 2019

(54) FOOT ACTUATED DOOR OPENER

(71) Applicant: LUKE MARKWAY, JEFFERSON CITY, MO (US)

(72) Inventor: LUKE MARKWAY, JEFFERSON CITY, MO (US)

(21) Appl. No.: 16/175,479

(22) Filed: Oct. 30, 2018

Related U.S. Application Data
(60) Provisional application No. 62/578,590, filed on Oct. 30, 2017.

(51) Int. Cl. E05B 53/00

(52) U.S. Cl. CPC E05B 53/001; E05F 11/54

(57) ABSTRACT

A door opener adapted to allow a user to open a door without requiring the use of a hand. The door has an automated latching system with a wireless receiver. The door opener has a bracket with a substantially rigid base plate that cradles a human foot. A set of screws attach the bracket to the door near the door bottom. The bracket supports a switch housing with a wireless transmitter and a switch. A pressure plate positioned on the bracket triggers the switch to send a wireless signal to the latching system receiver, which unlatches the door. The user can then swing the door with the user's foot on the bracket.

### CROSS REFERENCE TO RELATED APPLICATIONS

This application derives and claims priority from U.S. provisional application 62/578,590 filed Oct. 30, 2017, which U.S. provisional application is incorporated herein by reference.

### STATEMENT REGARDING FEDERALLY SPONSORED RESEARCH OR DEVELOPMENT

Not applicable.

### BACKGROUND OF THE INVENTION

The invention is related generally to devices for the automated or remote opening of doors without the use of hands, and more specifically, to a novel door opener that in certain embodiments enables the opening of a door by foot actuation without requiring any other engagement with the door, and that in other embodiments operates the latch of a door by foot actuation without requiring the foot to directly engage the latch while allowing the opening of the door by foot actuation.

Door openers are very old in the art, and many configurations of door opening devices exist that are currently available to the public. These include for example, various latches, handles, grips, knobs, locks, and hooks. Each of these devices has its own manner of engagement with the door to allow the opening of the door, and the vast majority of these devices require the use of one or both of a person's hands. For example, handles, grips and knobs all require the user to grasp the device with one or both hands and in some cases manipulate the device with the hand or hands to open the door. Yet, occasions can and do arise in which a door will need to be opened without the use of a hand. For example, when both hands are carrying items, when one or more of the hands or arms are injured, when the hands are dirty or soiled, or when the door is damaged or heated as from a fire and cannot be touched by hand. It is also desirable to enable the opening of a door without the use of hands when the spread of germs or other contagions or pathogens is of concern or to enable a disabled individual with limited functionality of the hands to open the door. Other such circumstances can be readily envisioned that would lead one to desire a mechanism to open a door without the use of hands.

However, while automated door openers exist that operate, for example, through the use of remote sensors, key codes and electronic passkeys, such openers have shortcomings. For example, the remote sensors require additional and sometimes complex electronics in order to operate. Passkeys require the use of a card or other physical device to activate the door, and such physical devices are subject to being lost, stolen or damaged. Further, such devices typically require the use of a hand or both hands to operate.

A need therefore exists for a compact, uncomplicated automatic door opener or door opening system that can be easily manipulated with a person's foot to mechanically open a door, particularly in conjunction with an automated delatching mechanism.

### BRIEF DESCRIPTION OF THE DRAWINGS

The illustrative embodiments of the present invention are shown in the following drawings which form a part of the specification:

FIG. 1 is a perspective view of a first representative embodiment of the foot base for the door opener of the present disclosure;

FIG. 2 is a perspective view of a second representative embodiment of the foot base for the door opener of the present disclosure;

FIG. 3 is a perspective view of a third representative embodiment of the foot base for the door opener of the present disclosure, the base generating a wireless signal;

FIG. 4 is a perspective view of a fourth representative embodiment of the foot base for the door opener of the present disclosure, the base generating a wireless signal;

FIG. 5 is a perspective view of a fifth representative embodiment of the foot base for the door opener of the present disclosure, the base generating a wireless signal;

FIG. 6 is a perspective view of a sixth representative embodiment of the foot base for the door opener of the present disclosure, the base generating a wireless signal;

FIG. 7 is a first exploded perspective view of the foot base of FIG. 3, sans the base's electronic components;

FIG. 8 is a second exploded perspective view of the foot base of FIG. 3, sans the base's electronic components;

FIG. 9 is a first exploded perspective view of the foot base of FIG. 4, sans the base's electronic components;

FIG. 10 is a second exploded perspective view of the foot base of FIG. 4, sans the base's electronic components;

FIG. 11 is an exploded perspective view of the foot base of FIG. 5, sans the base's electronic components;

FIG. 12 is an exploded perspective view of the foot base of FIG. 6, sans the base's electronic components;

FIG. 13 is a perspective view of a seventh representative embodiment of a foot base for the door opener of the present disclosure, the plate generating a wireless signal;

FIG. 14 is a perspective view of an eighth representative embodiment of a foot base for the door opener of the present disclosure, the plate generating a wireless signal;

FIG. 15 is a first exploded perspective view of the foot plate of FIG. 13, sans the foot base's electronic components;

FIG. 16 is a second exploded perspective view of the foot plate of FIG. 13, sans the foot base's electronic components;

FIG. 17 is a first exploded perspective view of the foot plate of FIG. 14, sans the foot base's electronic components;

FIG. 18 is a second exploded perspective view of the foot plate of FIG. 14, sans the foot base's electronic components;

FIG. 19 is an electronic schematic for a first representative embodiment of an electronic door latch used in association with certain embodiments of the foot base of the present disclosure;

FIG. 20 is an electronic schematic for a second representative embodiment of an electronic door latch, having a time delay circuit, used in association with certain embodiments of the foot base of the present disclosure;

FIG. 21 is a side view of the foot base of FIG. 1 attached to the base of a door, with an illustrative shoe depicted manipulating the base;

FIG. 22 is a side view of the foot base of FIG. 3 attached to the base of a door, with an illustrative shoe depicted triggering the wireless signal and manipulating the base;

FIG. 23 is a side view of the foot base of FIG. 4 attached to the base of a door, with an illustrative shoe depicted triggering the wireless signal and manipulating the base;

FIG. 24 is a side view of the foot base of FIG. 5 attached to the base of a door, with an illustrative shoe depicted triggering the wireless signal and manipulating the base;

FIG. 25 is a side view of the foot base of FIG. 6 attached to the base of a door, with an illustrative shoe depicted triggering the wireless signal and manipulating the base;

FIG. 26 is a side view of the foot plate of FIG. 13 attached to the base of a door, with an illustrative shoe depicted triggering the wireless signal and pushing on the plate;

FIG. 27 is a side view of the foot plate of FIG. 14 attached to the base of a door, with an illustrative shoe depicted triggering the wireless signal and pushing on the plate;

FIG. 28 is a partially exploded frontal plan view of the foot base of FIG. 4, showing the wireless electronics board and trigger mechanism, and optional front bumpers;

FIG. 29 is a partially exploded side plan view of the foot base of FIG. 4, showing the trigger mechanism, and optional front bumpers;

Corresponding reference characters indicate corresponding parts throughout the several views of the drawings.

### DETAILED DESCRIPTION OF THE INVENTION

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

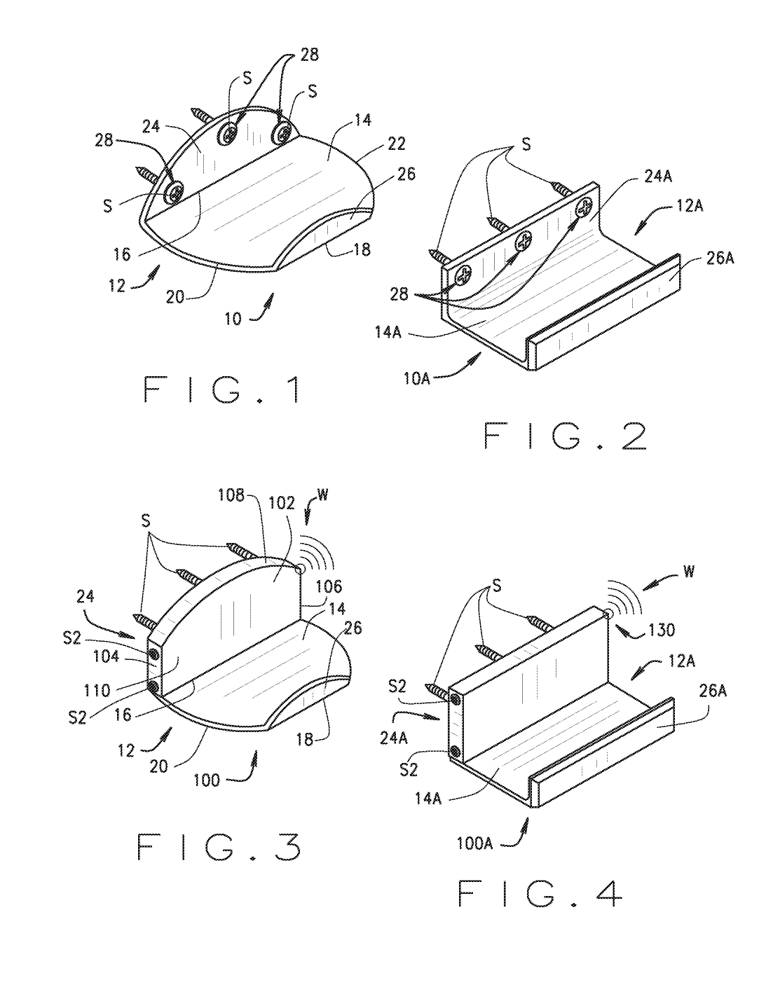

In referring to the drawings, a first representative embodiment of a foot base 10 for the novel door opener of the present invention is shown generally in FIGS. 1 and 2, where the present invention is depicted by way of example, both independently and in association with a door and associated latching mechanisms. The foot base 10 comprises a substantially rigid metal bracket 12 and three screws S, with the screws S adapted to attach the bracket 12 to a door D near the bottom of the door D. The bracket 12 has a thin, flat base plate 14 having a width of approximately 3 inches, with a straight proximal edge 16 on one side of the base plate 14 and a straight distal edge 18 opposite and parallel to the proximal edge 16 on the other side of the base plate 14. A first side edge 20 and a second side edge 22 extend as mirrored inward sloping convex curves from the distal edge 18 to opposite ends of the proximal edge 16.

A rear plate 24 projects upward from and perpendicular to the proximal edge 16. The base of the rear plate 24 extends the full length of the proximal edge 16 and gradually and uniformly arches upward across its full length to form an arc with a maximum height at its center point of approximately one inch above the proximal edge 16. Similarly, a front plate 26 projects upward from and perpendicular to the distal edge 18. The base of the front plate 26 extends the full length of the distal edge 18 and gradually and uniformly arches upward to form an arc across its full length to a maximum height at its center point of approximately ½ inch above the distal edge 18.

Three screw holes 28 are formed in the rear plate 24, with one screw hole 28 positioned at the center and near the top of the rear plate 24, and each of the other two screw holes 28 positioned at opposing ends of the rear plate 24. The screw holes 28 are configured to receive the shanks of the screws S to enable the screws to secure the bracket 12 to a door D as shown in FIG. 22.

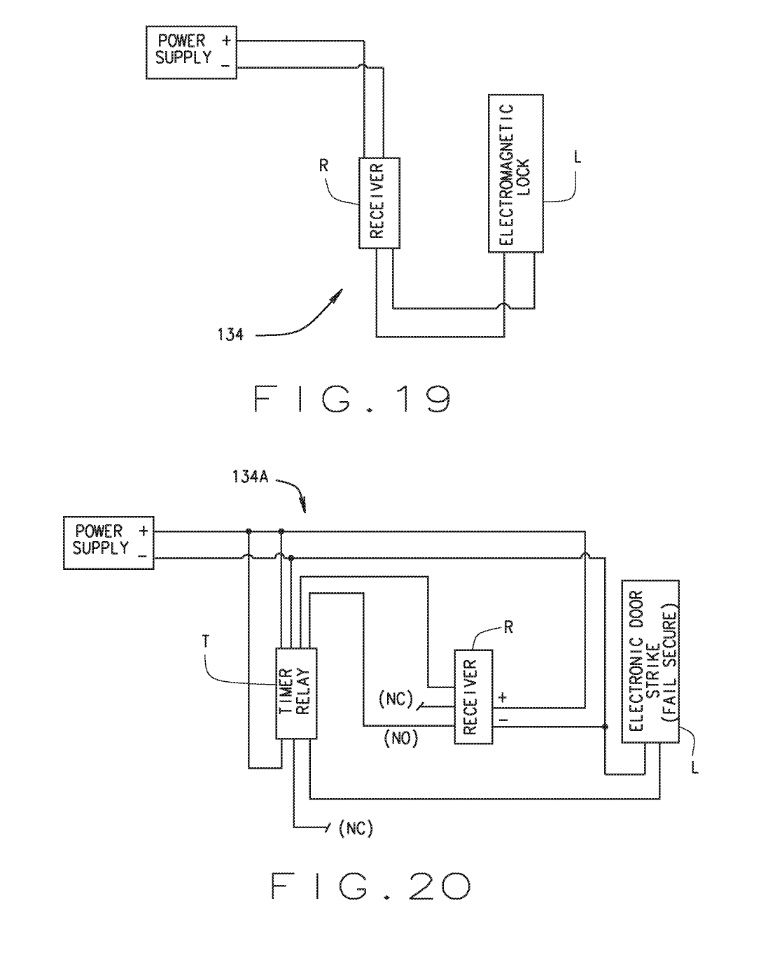

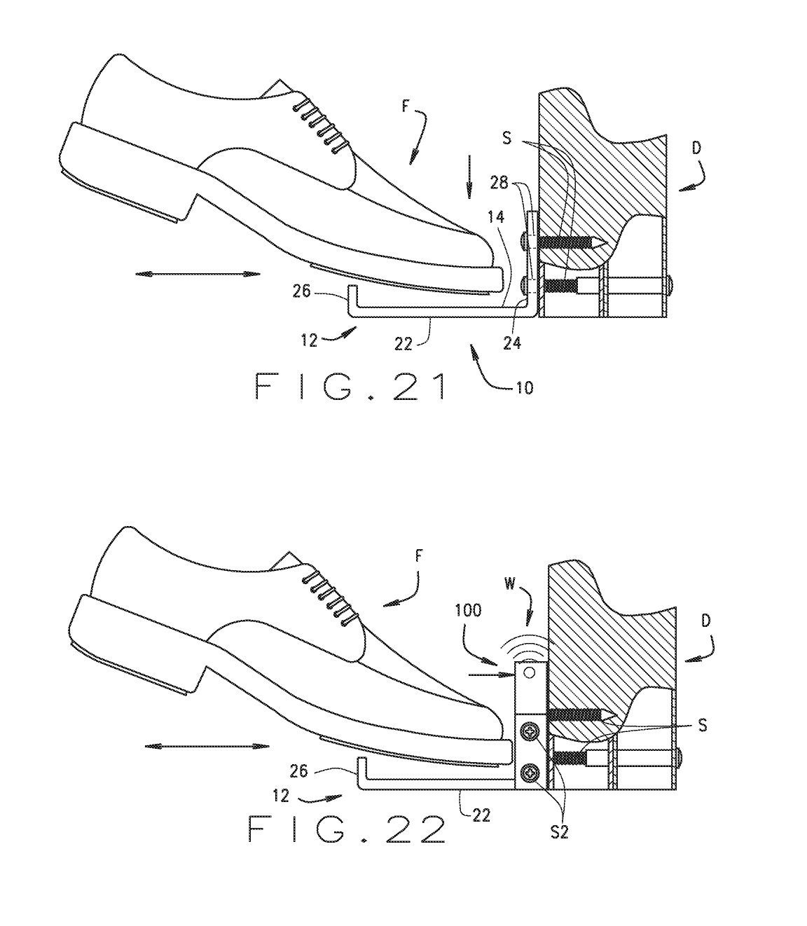

The foot base 10 is adapted to operate in conjunction with an automated door latching system that locks and unlocks the door D such as for example, a latch operated by a keycard, a biometric sensor or a motion sensor. A first representative electronic schematic of a representative automated latch is shown in FIG. 19, and a second representative electronic schematic of a representative automated latch with a delay timing circuit is shown in FIG. 20.

As shown in FIG. 22, when the bracket 12 is secured to the door D near the base of the door D, a user may use a foot F (depicted as a shoe) to engage and press downward on the bracket 12. Then, when the door D is unlatched by the automated door latching system, the user can use the foot F engaged with the bracket 12 to selectively pull or push on the bracket 12 to thereby pull or push the door D into an open position—all without further use of the user's hands. Of course, if the door D is already open, the user can use the foot F to engage the bracket 12 to fully or partially close the door D as desired. Also, it is not required that the user first engage the bracket 12 before the door D is unlatched.

The specific shape of the various components of the bracket 12 can vary substantially, so long as the bracket 12 can be securely attached to the door D near the base of the door, and provides a suitable shape for a user to engage with a foot F to open and close the door D as described herein. For example, FIG. 2 depicts a second embodiment 10A of the foot base of the novel door opener having a bracket 12A configured with a rectangular base plate 14A, a rectangular front plate 26A and a rectangular rear plate 24A.

A third representative embodiment 100 of the foot base of the novel door opener of the present invention is shown generally at FIGS. 2, 7-8 and 23, where the present invention is depicted by way of example, both independently and in association with a door and associated latching mechanisms. FIG. 4 depicts a fourth embodiment 100A of the foot base of the novel door opener of the present invention, which comprises the same features as the foot base 10A, with addition of a wireless transmitter apparatus, but in a rectangular configuration. Hence, the foot base 100A is a rectangular-shaped version of the foot base 100, with a bracket 12A having a rectangular base plate 14A, a rectangular rear plate 24A, a rectangular front plate 26A, and a rectangular switch housing 102A with a rectangular kick plate 110A.

More particularly, the foot base 100 comprises a substantially rigid metal switch housing 102, having a uniform thickness of approximately ½ inches, abuts and is attached to the rear plate 24. The bottom of the switch housing 102 extends the full length of the proximal edge 16. The switch housing 102 has a first end 104, and an opposing second end 106, with an upwardly curved top 108. The first end 104 and second end 106 both extend approximately 1½ inches above and perpendicular to the base plate 14. The top 108 gradually and uniformly arches upward across its full length to a maximum height at its center point of approximately two inches above the proximal edge 16. The first end 104, second end 106 and top 108 all define the sides and upper edge of a substantially rigid metal pressure or kick plate 110 that is parallel to the front plate 26.

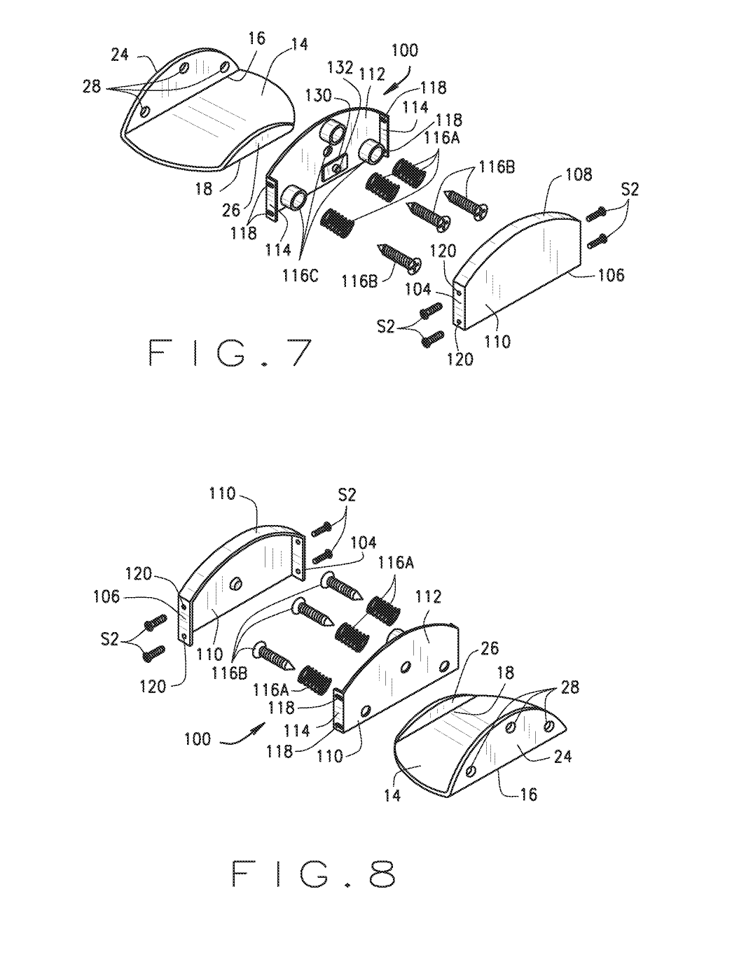

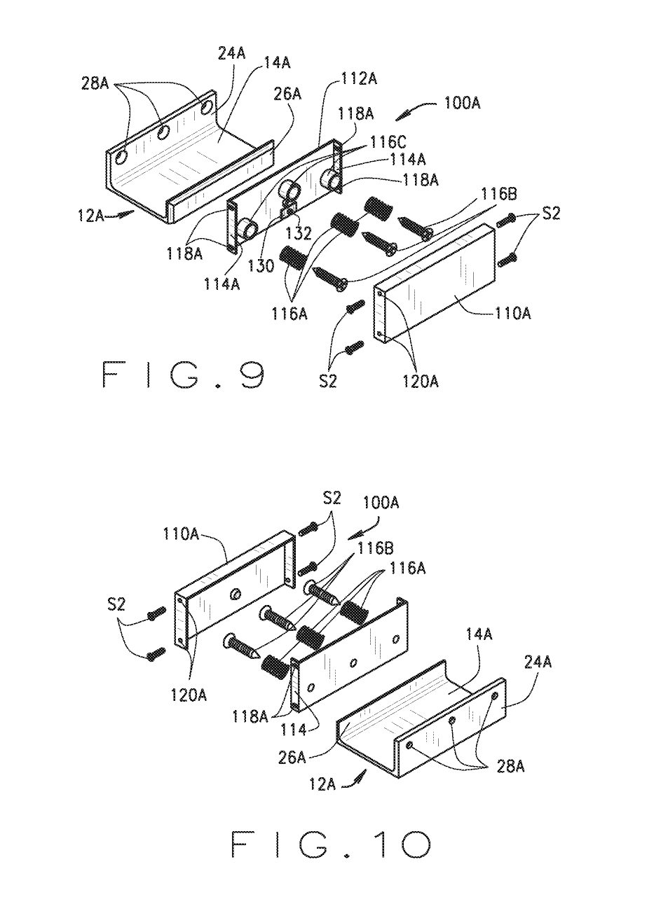

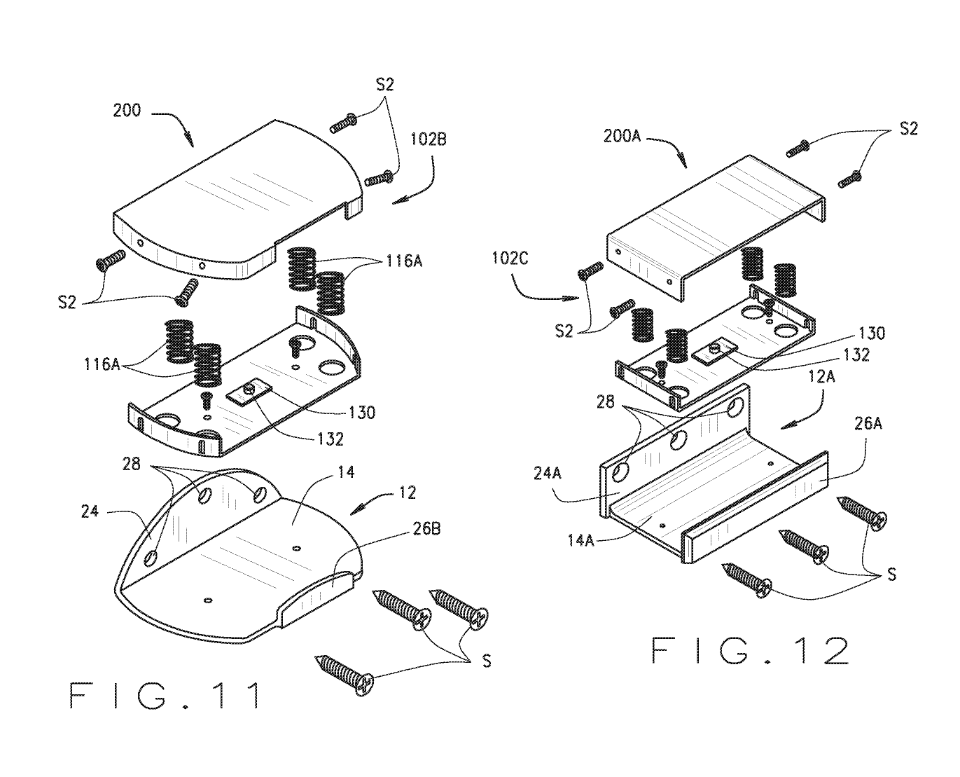

Referring now to FIGS. 7 and 8, it can be seen that the switch housing 102 comprises the kick plate 110, which conforms to the outer shape of the switch housing 102, and a substantially rigid metal rear plate 112, which is parallel to but opposite the kick plate 110. Two parallel straight, thin side plates or tabs 114 extend perpendicularly from each end of the rear plate 112 toward the kick plate 110. Three spring assemblies 116 operatively separate the kick plate 110 from the rear plate 112 and impart a spring bias between the kick plate 110 from the rear plate 112. Each of the spring assemblies 116 comprises a spring 116A surrounding a screw 116B that slips into a sleeve 116C that extends perpendicularly from the kick plate 110 toward the rear plate 112.

To allow the kick plate 110 to move in a controlled manner relative to the rear plate 112, a pair of horizontal slots 118 are formed in each of the tabs 114. The tabs 114 align with screw holes 120 formed in the first end 104 and second end 106 of the kick plate 110. The screw holes 120 are sized and threaded to mate with screws S2, and the slots 118 are just wide enough to allow the shanks of the screws S2 to pass through. The screws S2 must be long enough to pass entirely through the screw holes 120 and extend at least in part through the slots 118 when the kick plate 110 is positioned over the rear plate 112. In this way, when the rear plate 112 is properly positioned within the kick plate 110 and the screws S2 are secured in the screw holes 120, all as indicated in FIGS. 7 and 8, the kick plate 110 is free to travel horizontally forward and back over the rear plate 110 but only for the length of the slots 118.

We refer now to FIGS. 28 and 29, which depict the positioning and operation of a wireless transmitter and associated switch in an alternate embodiment having a horizontal switch housing. One of ordinary skill will understand that by correlation, these same components are positioned in the same manner in the foot base 100 but in a vertical (as opposed to horizontal) orientation. Thus, it will be understood from FIGS. 28 and 29, when correlated to FIGS. 7 and 8, that the foot base 100 further includes a switch assembly 130 attached to the rear plate 112. The switch assembly 130 has a wireless transmitter 131 and a trigger 132 for the transmitter 131 that is operatively associated with the kick plate 110. The trigger 132 and the kick plate 110 are positioned relative to one another such that when the kick plate 110 is pushed or kicked against the trigger 132, the trigger will activate the transmitter 130 to generate a wireless signal, representatively depicted as W. The spring assemblies 116 will maintain a separation between the trigger 132 and the kick plate 110 such that the trigger 132 will only activate when sufficient force is applied to the kick plate 110 to overcome the bias of the springs 116A, such as when kicked or pressed firmly. Upon actuation of the trigger 132, the wireless transmitter 131 generates a wireless signal that is received by a wireless receiver R of an electronic automated door latching mechanism or system, such as the system 134 (FIG. 19) or the system 134A (FIG. 20).

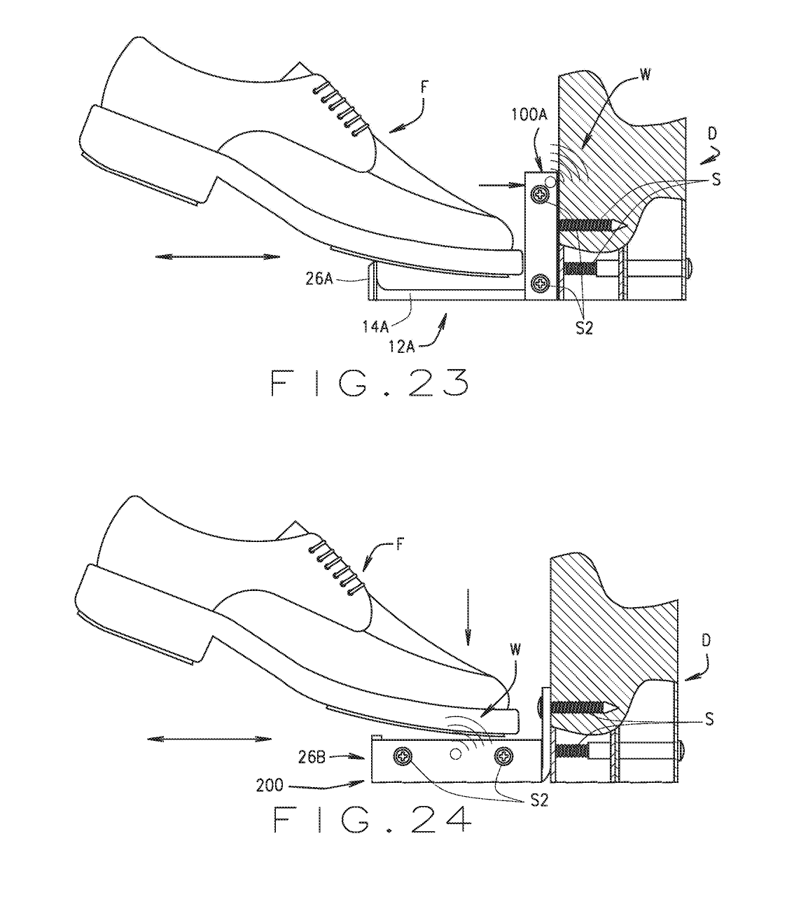

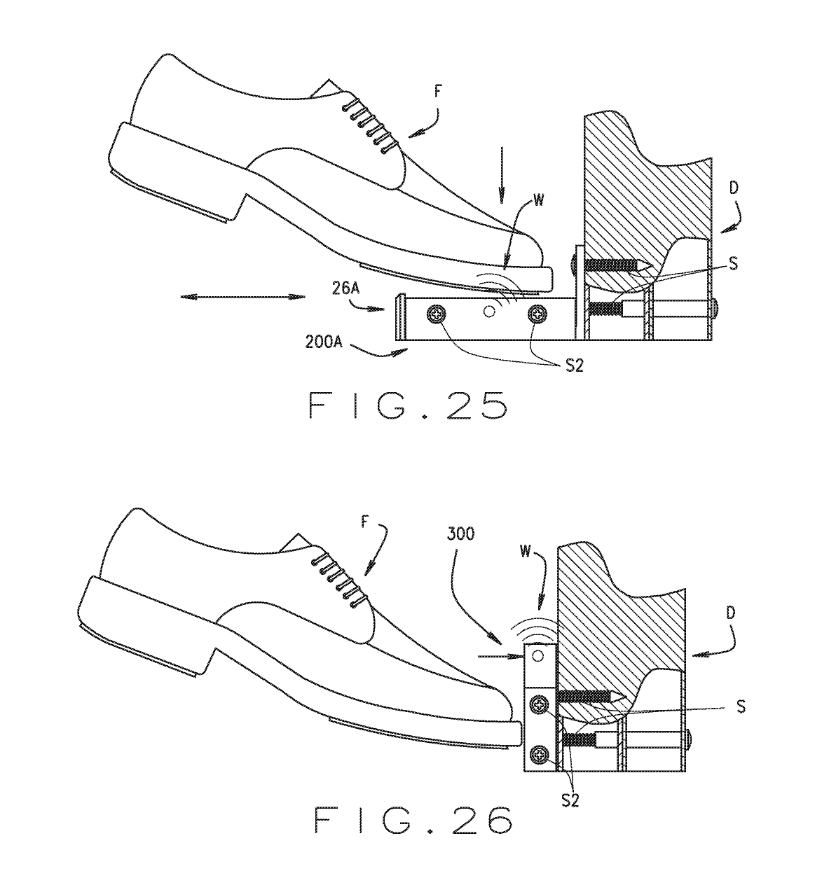

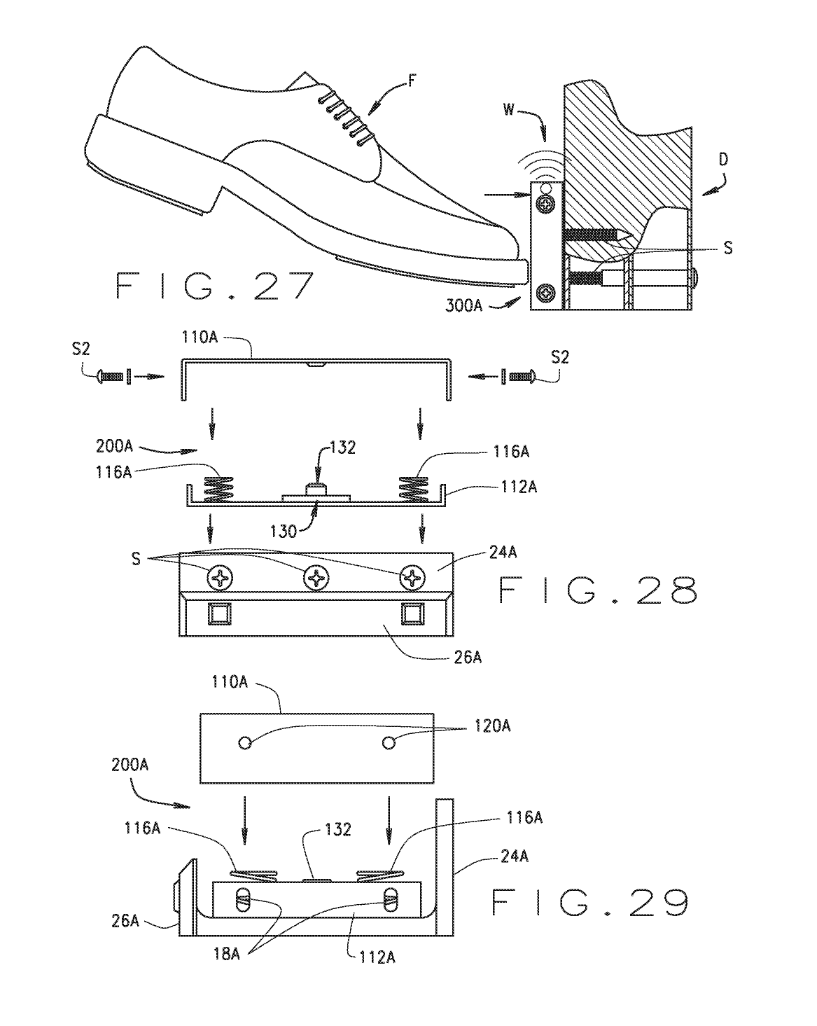

The door latching system 134 has an automatic latch L, such as for example a solenoid driven gate mechanism, that latches the door D in a closed position. When the door latching system 134 receives the trigger signal from the transmitter 131, the door latching system 134 then opens the automatic latch L and unlatches the door D (FIG. 23) such that the user can open the door D by manipulation of the bracket 12 with the user's foot. Of course, the foot base 100 is not limited to the use of a wireless transmitter 131, but can comprise alternatively wired communication between the switch assembly and the door latching system 134. The door latching system 134A (FIG. 20), is the same as the door latching system 134, except that it also includes a timer relay T that allows the user to set a desired time delay such that after the system 134A receives the wireless signal W from the foot base 100, the latch L not unlatch the door D until the desired time delay has passed.

The foot base 100 may further be adapted to operate in conjunction with an automated door locking system that locks and unlocks the door D such as for example, a lock that activates with a keycard, a biometric sensor or a motion sensor.

As shown in FIG. 23, when the bracket 12 of foot base 100 is secured to the door D near the base of the door D, a user may use a foot F (depicted as a shoe) to push or kick the kick plate 110. The spring assemblies 116 (see FIGS. 7 and 8) hold the kick plate 110 in separation from, but in parallel alignment with, the rear plate 112, such that when the kick plate 110 is pushed toward the rear plate 112, the kick plate 110 then activates the trigger 132, which in turn activates the wireless transmitter 131 to generate a wireless signal W that is received by the wireless receiver R associated with the automated door latching system 134, which then activates the actuator to operate the door D latching mechanism and thereby unlock the door D. Then, when the door D is unlocked by the automated door latching system, the user can use the foot F engaged with the bracket 12 to selectively pull or push on the bracket 12 to thereby pull or push the door D into an open position without further use of the user's hands. Of course, if the door D is already open, the user can use the foot F to engage the bracket 12 to fully or partially close the door D as desired. Also, it is not required that the user first engage the bracket 12 before the door D is unlocked or unlatched.

A fifth representative embodiment 200 of the foot base of the novel door opener of the present invention is shown generally at FIGS. 5 and 11, where the present invention is depicted by way of example. This sixth embodiment 200 comprises substantially the same components as the third embodiment 100, except that the switch housing 102B is positioned horizontally atop, and mirrors the peripheral contours of, the base plate 14. As can be seen in FIGS. 11 and 12, all of the associated trigger and transmitter components inside still positioned within the switch housing 102B. It will be noted that the front plate 26B has a slightly different shape than the front plate 26 of the foot base 100. However, the foot base 200 is otherwise configured the same as the foot base 100.

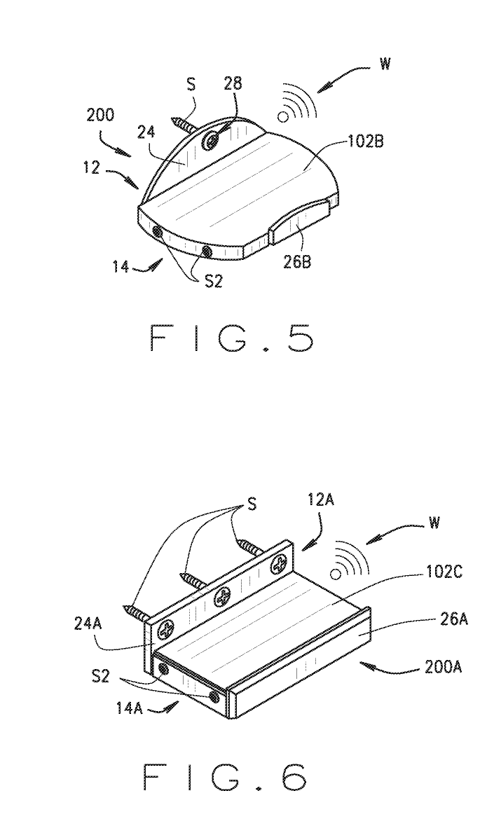

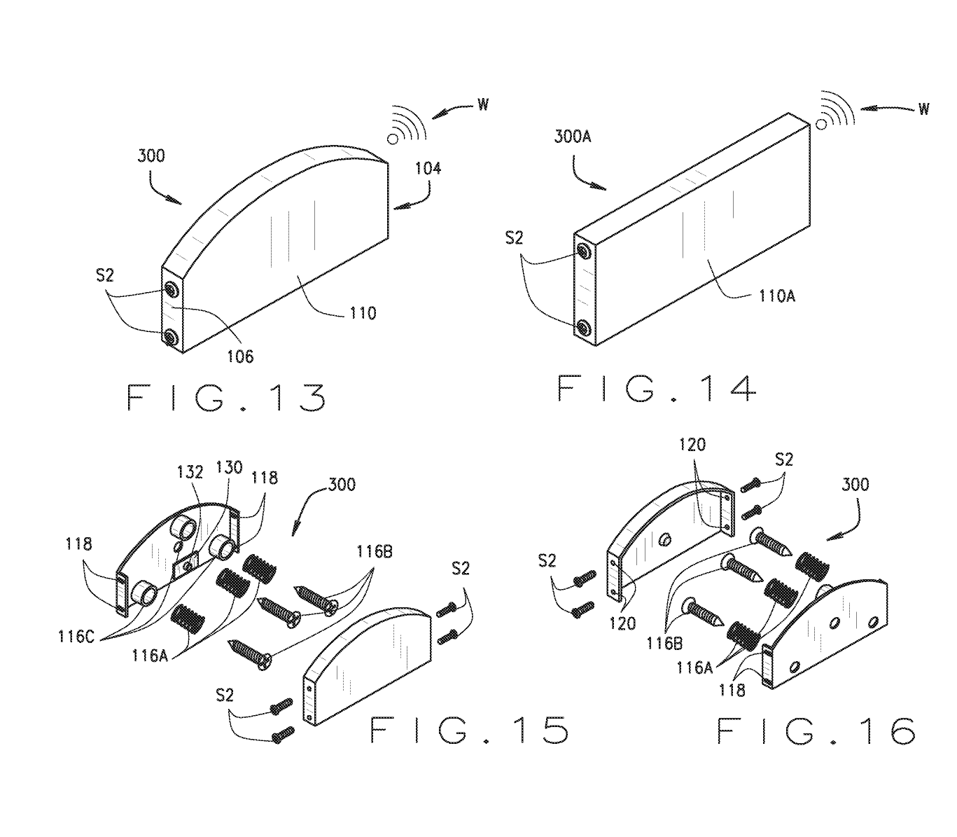

Similarly, a sixth representative embodiment 200A of the foot base of the novel door opener of the present invention is shown generally at FIGS. 6 and 12, where the present invention is depicted by way of example. This foot base 200A comprises substantially the same components as the third embodiment 100A, except that the switch housing 102C is positioned horizontally atop, and mirrors the peripheral contours of, the base plate 14A. As can be seen in FIGS. 13 and 14, all of the associated trigger and transmitter components inside still positioned within the switch housing 102C.

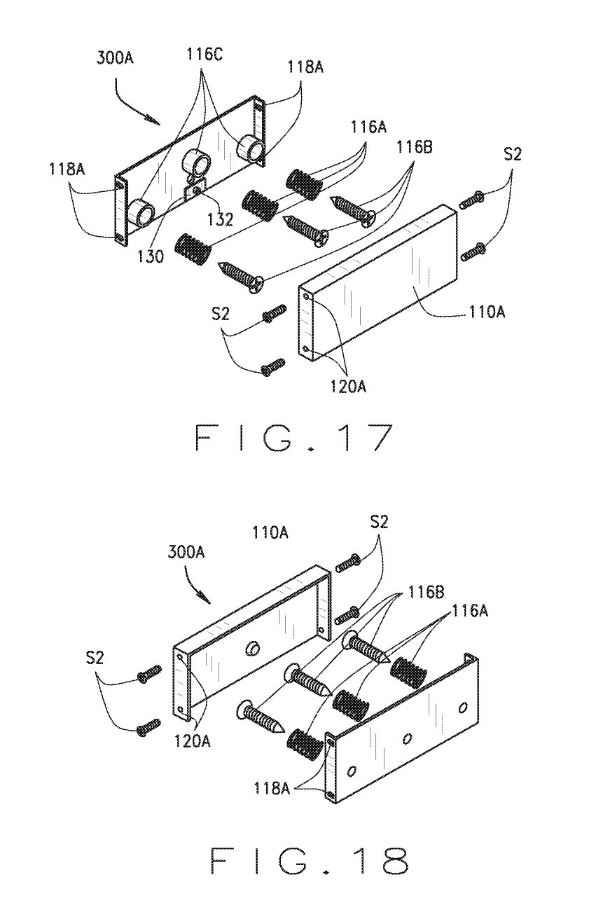

A seventh representative embodiment 300 of the foot base of the novel door opener of the present invention is shown generally at FIGS. 13, 15 and 16, where the present invention is depicted by way of example. This foot base 300 has the same configuration as foot base 100, except that has no base plate 14 or front plate 26. Consequently, the foot base 300 is only allows the door to be pushed in one direction by the user's foot—i.e., the foot base 300 does not provide a surface upon which the user can “pull” on the door.

Similarly, an eighth representative embodiment 300A of the foot base of the novel door opener of the present invention is shown generally at FIGS. 14, 17 and 18, where the present invention is depicted by way of example. This foot base 300A has the same configuration as foot base 100A, except that has no base plate 14A or front plate 26A. Consequently, the foot base 300A is only allows the door to be pushed in one direction by the user's foot—i.e., the foot base 300A does not provide a surface upon which the user can “pull” on the door.

As will be appreciated, it is fully contemplated that each of the embodiments of the foot base (i.e., 10, 10A, 100, 100A, 200, 200A, 300 and 300A) can be adapted to operate in conjunction with either of the representative automatic door latching systems 134 and/or 134A depicted in electronic schematics of FIGS. 19 and 20. Of course, such schematics are only representative, and one skilled in the art will understand that numerous varied configurations of such automated door latching systems exist in the art. It will likewise be appreciated that for the door opener of the present invention to open a door D for which it is being used, the door base (e.g., 100, 100A, 200, 200A, 300 and 300A) attached to the door D need only communicate, preferably in a wireless manner, with such latching system to allow the door opener to allow the opening of the door D by the user's foot as disclosed herein.

It is also contemplated that the door base (e.g., 100, 100A, 200, 200A, 300 and 300A) may be configured as a stand-alone or after-market product that may be used to work in applications having existing automated door latching systems. Hence, the present invention encompasses the door base (e.g., 100, 100A, 200, 200A, 300 and 300A) independent of an associated door latching system. When used in conjunction with such door latching systems, the door base and such systems collectively form a door opener of the present invention.

While I have described in the detailed description several configurations that may be encompassed within the disclosed embodiments of this invention, numerous other alternative configurations, that would now be apparent to one of ordinary skill in the art, may be designed and constructed within the bounds of my invention as set forth in the claims. Moreover, the above-described novel door opener, such as for example, the door bases 10, 10A, 100, 100A, 200, 200A, 300 and 300A, of the present invention can be arranged in a number of other and related varieties of configurations without departing from or expanding beyond the scope of my invention as set forth in the claims.

For example, the base plate (e.g., 14 and 14A) and front plate (e.g., 26 and 26A) may be configured in a wide variety of shapes and sizes, and can be configured in a variety of shapes and orientations relative to the door D other than horizontal (for the base plate) and vertical (for the front plate), so long as the base plate and front plate provide a platform that allows a user to manipulate the foot base and open the door D with the user's foot generally as disclosed. Similarly, the rear plate, such as 24 and 24A, may be configured in a wide variety of shapes and sizes, so long as the rear plate provides a stable platform to attach the foot base (e.g., 12 and 12A) to the door D.

By way of further example, the switch housings (e.g., 102, 102A) are not limited to the shapes and sizes described herein. Rather, the door opener switch housing may be in a wide variety of shapes and sizes, and (as seen by the differences between the foot bases 100/100A and 200/200A) may be attached to the bracket (e.g. 12, 12A) in various manners. For example, the switch housing may be attached under or on one side of the bracket 12/12A; the switch housing may be configured to cover only a portion of the plate to which it attaches; the switch housing may be thicker or thinner than as shown; the switch housing may be configured to expose a trigger for actuation, instead of requiring a kick plate to actuate the trigger.

By way of further example, the foot base having a wireless transmitter (e.g. 100 and 100A; 200 and 200A) may be configured with a wide variety of trigger actuation components that differ from those shown, so long as the door opener allows a user to actuate the trigger with the user's foot, generally as shown. For example, the number of springs 116A and associated screws 116B and sleeves 116C need not be three, but can alternately be any number of such components so long as the trigger actuation achieves the results described herein.

By way of further example, the automatic door latching systems depicted as electronic schematics in FIGS. 19 and 20 are merely representative. That is, one of ordinary skill in the art will recognize that a wide variety of such automatic door latching systems are readily available in the art, and that the foot base (e.g., 100, 100A, 200, 200A, 300 and 300A) can be readily adapted to interface with and thereby operate in conjunction with virtually all such latching systems merely by synching the wireless transmitter of the foot base with the wireless receiver of the latching system.

By way of further example, while most of the components of the foot base (e.g., 100, 100A, 200, 200A, 300 and 300A) are described as being constructed of metal, such components may alternatively be constructed of various other materials of varying dimensions, so long as the components all function properly to meet their purposes as described herein.

By way of further example, while the foot base (e.g., 100, 100A, 200, 200A, 300 and 300A) is described as interfacing wirelessly with an automatic door latching system, the foot base can alternatively be adapted to interface through a “hard” or wired connection with such automatic door latching system.

By way of further example, the screws S can be of varying quantity and sizes and shapes, so long as the screws S perform their desired function of providing structure to the springs for the kick plate, and securing the foot base to the door D. Further, a wide variety of attachment devices and configurations can be implemented to secure the foot base to the door D, including for example, bolts, latches, hooks, interlocking plates, adhesives, and clamps.

Additional variations or modifications to the configuration of the various components of the novel door opener, including the door opener foot bases 10, 10A, 100, 100A, 200, 200A, 300, 300A, of the present invention may occur to those skilled in the art upon reviewing the subject matter of this invention. Such variations, if within the spirit of this disclosure, are intended to be encompassed within the scope of this invention. Therefore, the description of the embodiments as set forth herein, and as shown in the drawings, is provided for illustrative purposes only and, unless otherwise expressly set forth, is not intended to limit the scope of the claims, which set forth the metes and bounds of my invention.

What is claimed is:

1. A door opener adapted to allow a user to open a door without requiring the use of a hand, the door having a bottom, the door having an automated latching system for latching and unlatching the door, the opener comprising:
a. a bracket, said bracket having a substantially rigid base plate configured to cradle at least in part a human foot, said bracket configured for attachment to the door in proximity to the door bottom; and
b. one or more attachment devices, said attachment devices attaching said bracket to the door in proximity to said base.

2. The door opener of claim 1, further comprising a wireless transmitter and a switch operatively associated with said wireless transmitter, said wireless transmitter controllably generating and transmitting a wireless signal, said switch selectively activating said wireless transmitter to generate said wireless signal and selectively deactivating said wireless transmitter to cease generating said wireless signal.

3. The door opener of claim 2, wherein said automatic latching system comprises a wireless receiver and a computer control unit operatively associated with the wireless receiver, the wireless receiver being operatively associated with the wireless transmitter, the wireless receiver receiving the wireless signal from the wireless transmitter, the computer control unit being operatively associated with an actuator controlling a latch for the door, said computer control unit directing the actuator to open the latch when said wireless receiver receives the wireless signal from the wireless transmitter.

4. The door opener of claim 3, wherein said computer control unit directs the actuator to close the latch when said wireless transmitter ends the wireless signal to the wireless receiver.

5. The door opener of claim 3, wherein said automatic latching system comprises a timing circuit operatively associated with the computer control unit, said timing circuit selectively generating a timed delay between the moment when the wireless transmitter begins transmission of the wireless signal and the moment when the computer control unit directs the actuator to open the latch.

6. The door opener of claim 4, wherein said automatic latching system comprises a timing circuit operatively associated with the computer control unit, said timing circuit selectively generating a timed delay between the moment when the wireless transmitter ceases transmission of the wireless signal and the moment when the computer control unit directs the actuator to close the latch.

7. The door opener of claim 2, further comprising a switch housing, wherein said wireless transmitter is positioned at least in part within said housing.

8. The door opener of claim 7, wherein the switch housing comprises a kick plate and a trigger operatively associated with the kick plate and said switch, said kick plate having a first position in which the kick plate does not engage the trigger and a second position in which the kick plate engages the trigger, said trigger activating the switch to direct the wireless transmitter to generate the wireless signal when the kick plate engages the trigger.

9. The door opener of claim 7, wherein the kick plate is substantially horizontal or substantially vertical.

10. A door opener adapted to allow a user to open a door without requiring the use of a hand, the door having a bottom, the opener comprising:
a. a bracket, said bracket having a substantially rigid base plate configured to receive at least in part a human foot, said bracket configured for attachment to the door in proximity to the door bottom;
b. one or more attachment devices, said attachment devices attaching said bracket to the door in proximity to said base;
c. a switch attached to said bracket, said switch having an ON position and an OFF position, said switch being capable of operation by a human foot;
d. a wireless transmitter operatively associated with said switch, said wireless transmitter controllably generating and transmitting a wireless signal, said switch selectively activating said wireless transmitter to generate said wireless signal when said switch is in its ON position, and said switch selectively deactivating said wireless transmitter to cease generating said wireless signal when said switch is in its OFF position; and
e. an automated latching system for latching and unlatching the door, said system comprising a wireless receiver and a computer control unit operatively associated with the wireless receiver, the wireless receiver being operatively associated with the wireless transmitter, the wireless receiver receiving the wireless signal from the wireless transmitter, the computer control unit being operatively associated with an actuator controlling a latch for the door, said computer control unit directing the actuator to open the latch when said wireless receiver receives the wireless signal from the wireless transmitter.

11. The door opener of claim 10, wherein said computer control unit directs the actuator to close the latch when said wireless transmitter ends the wireless signal to the wireless receiver.

12. The door opener of claim 10, wherein said automatic latching system comprises a timing circuit operatively associated with the computer control unit, said timing circuit selectively generating a timed delay, said timed delay being selectively imposed on one of said: between the moment when the wireless transmitter begins transmission of the wireless signal and the moment when the computer control unit directs the actuator to open the latch, and between the moment when the wireless transmitter ceases transmission of the wireless signal and the moment when the computer control unit directs the actuator to close the latch.

13. The door opener of claim 10, further comprising a trigger positioned proximate the bracket and operatively associated with the switch, said trigger turning the switch to its ON position when the trigger is activated, said trigger allowing the switch to return to its OFF position when the trigger is deactivated.

14. The door opener of claim 13, further comprising a pressure plate operatively associated with the trigger, said pressure plate activating the trigger when a predetermined amount of pressure is applied to the pressure plate

15. The door opener of claim 14, wherein the switch housing comprises the pressure plate.

16. The door opener of claim 14, wherein the pressure plate is one of substantially horizontal or substantially vertical.

17. The door opener of claim 10, wherein the base plate is substantially horizontal.
